(19) United States
(12) Patent Application Publication
(10) Pub. No.: US 2022/0316449 A1
(43) Pub. Date: Oct. 6, 2022

(54) Gravitational Electric Power Plant Technology

(71) Applicant: FILFIL IP Inc., Ottawa (CA)

(72) Inventor: Shafi Quraishy, Dubai (AE)

(21) Appl. No.: 17/503,938

(22) Filed: Oct. 18, 2021

Related U.S. Application Data
(63) Continuation of application No. 13/996,085, filed on Jun. 20, 2013, now abandoned.

(51) Int. Cl. F03G 3/00; F03G 3/08; F03G 7/10

(52) U.S. Cl. CPC F03G 3/00; F03G 3/08; F03G 7/10

(57) ABSTRACT

An apparatus, system and methods that on the one hand, maximize work done by gravity, by allowing free fall of an object with a heavy mass to harness energy and output therefrom, and on the other, maximizes efficiency by counterbalancing this heavy mass by another similar mass such that only the net difference of the said two masses needs to be worked upon by input power mechanisms in order to lift the fallen object back up to its original position, along the direction of gravity or otherwise, to repeat the cycle. A plurality of such units are employed in synchronized tandem to maintain a steady RPM of the gear/flywheel/shaft connecting a high output generator. Still further, auxiliary energy generation mechanisms to further augment efficiency of the system are disclosed.

### FIELD OF THE INVENTION

This invention relates to the field of harnessing gravitational force and to the conversion of the work done by gravitational force into other forms of energy and/or work. More particularly this invention relates to generation of electrical energy by harnessing gravitational force either solely or in combination with other forms of energy (renewable or non-renewable), with special focus on resource-economy, minimal pollution and externalities.

### BACKGROUND OF THE INVENTION

The industrial revolution radically influenced almost every aspect of human life and in pursuit of sophistication and advancement, man's dependencies not only shifted, but also increased exponentially. Today machines created by man govern his life—his households, businesses, transport, agricultural output, food processing, warfare, economy, as well as dictate the quality of his future. Since all machines need power (energy) to process their input, demand for power too has exponentially increased and today the ability to generate enough power is among the key factors that decide a country's stature in the international economic and political arena. Focus until recent decades had been on conventional non-renewable resources (Fossil fuels such as coal, petroleum, and natural gas, and later, types of nuclear power such as from radioactive uranium, and certain aquifers) to meet power demands. But our power plants and heating-cooling-cooking-burning practices are now producing more greenhouse gases than we can tolerate to maintain a stable climate. The international climate science community cautions us to drastically cut our carbon emissions. Further, we are now approaching peak oil and gas production, in which half the amount of total known global supply has already been used, with steadily increasing prices to come; and “clean coal”, “sustainable biomass”, “safe nuclear” and other such clichés seem mere illusions. The only remaining choices quoted by the international scientific community for our energy future are the ‘Renewables’—hydropower, geothermal, biomass, solar thermal, solar electric, wind, tides, waves, ocean-thermal-gradients, and new, unconventional technologies.

Existing nonrenewable and renewable energy generation technologies and their contribution to the global energy is approximately thus; NONRENEWABLES (93%); —1. Combustion of petroleum-based fuels (39%), 2. Combustion of natural gas (24%), 3. Combustion of coal and its derivatives (24%), 4. Hydrogen derived from petroleum, natural gas, or coal, 5. Uranium and plutonium fission-based nuclear reactors that are highly radioactive (5%), 6. “Hot fusion”: RENEWABLES (7%); —7. Wind-based generation systems (0.2%), 8. Solar-based heating and power generation systems (0.1%), 9. Geothermal-based heating and power generation systems (0.4%), 10. Biofuels (ethanol and biodiesel) (1%), 11. Biomass combustion (mostly wood chips) (2%), 12. Fuel cells, 13. Anaerobic digestion of waste to biogas, 14. Conventional hydroelectric generators (3%).

Several experiments and inventions using gravity form part of literature relevant to the power sector. However, one common approach taken by many an inventors is to build a self sustaining machine using gravity, to generate power—which may seem feasible in theory, but isn't so practice—especially in the context of producing substantial amounts of power that can be harvested to run other machines/appliances. This is primarily due to the fact that the work done by gravity on a given (self sustaining) machine is barely enough to sustain itself, and the prospects of additional power generation are therefore unrealistic. For instance US20090115195, a gravity power generation mechanism seeks to run the power generation unit by running a series of single-directional-swing arms that tend to stretch outward on only one side, as they circle the said unit, so as to produce a larger positive torque (purportedly due to the outstretched arms on one side), that would impel and sustain continuous rotational motion of that unit. This however is not true in practice since a greater number of collapsed arms collect on the opposite side and cancel out the positive torque created by the fewer outstretched ones. In Indian Patent No. 207600 (649/MUM/2004), the claimed apparatus seeks to use gravitational force exerted on a falling object suspended by a rope and pulley, to rotate a fly wheel which is said to store the rotational kinetic energy, and which in turn is said to lift the (fallen) object upward; and this cycle of alternate upward-downward movement of the said weight is claimed to be used to rotate a dynamo shaft to generate electricity. This is again not a sustainable design for efficient power generation since it contradicts the 2^{nd} law of thermodynamics that states that some energy in a system is always lost (including during transmission), and therefore a machine cannot make more energy than it uses or even enough to keep itself operating indefinitely.

It is therefore imperative that an external force be employed to sustain additional work done by a machine, especially one that uses gravity. Therefore in U.S. Pat. No. 6,445,078, an elevated water reservoir fills a plurality of containers that travel downward under the weight of the water and this ‘controlled’ gravity influenced movement is made to drive a generator, while the said containers after reaching down, are emptied and carried back up by an ad hoc powered mechanism. In U.S. Pat. No. 5,905,312 too, a similar concept is applied wherein water or other fluid from an elevated reservoir feeds secondary tanks that glide under the influence of gravity along a controlled downward path and are emptied into another floor reservoir. This downward gravity induced motion is harnessed to rotate a generator shaft with the help of gears. Water emptied by the said secondary tanks is pumped back into the elevated tank by an ad hoc powered pump. In these systems however, since the downward movement is ‘controlled’ and is not a free fall, the entire work done by gravity on the load is not available to be harnessed, which directly affects the efficiency of the said systems. Besides, factors including the time taken to fill water into each container/tank, the rate at which water/fluid is fed back into the reservoir, and the maximum feasible size of each container/tank etc., limit the scalability of the set-up and are not ideal for very high power generation requirements, such as those that power a 15 township or even a reasonably large industrial installation. In U.S. Pat. No. 8,011,182, US20110179784 and in US20110162356, gravity acts on a series of buckets fastened to a chain or belt, that descend downward in a liquid medium due to their mass/weight (gravity). Once they reach the bottom, they are filled with gas or other lighter fluid/medium, that renders them buoyant thereby causing their ascent (upward), and upon 20 reaching the top the gas is released out of the buckets. This cyclic upward-downward movement is used to run a generator shaft to produce electricity. Here again, the velocity of descent, and the rate at which gas is refilled into each bucket, the largest feasible size of a bucket, and the torque that can be so created etc., limit the scalability of the invention which cannot be used for high power generation requirements.

It is therefore apparent from prior art (inventions) that gravity based models thus far have not been able to cater to large or even medium scale power requirements. Gravity being free, perennial, ubiquitous, ecologically safe and above all—directly proportional to product of the mass of the object in question (—promising remarkable efficiency), and independent of climate, season, weather, wind, sunshine, tide, rain, geography or other resources etc., presents an avenue to an urgent as well as long felt need for a viable solution that is safe and sustainable, and that effectively harnesses gravitational force and efficiently converts the work done by gravity into other forms of energy, particularly electrical energy, especially at a very large scale.

This inventor has developed an apparatus, system and method/s that effectively harnesses gravitational force and efficiently convert work done by gravity into other forms of energy, especially electrical energy, and that is versatile and almost illimitable as to its scalability.

### OBJECTS OF THE INVENTION

It is therefore the main object of this invention to effectively harness work done by gravitational force, and to efficiently convert the same to other forms of energy and/or work, more particularly electrical energy, in an economical, eco-friendly and safe manner.

It is another main object of this invention to design and implement an apparatus, system and method/s that harness and convert gravitational force so as to generate large, medium and small scale electric power, whereby the aspect of scalability is almost illimitable, applicable anywhere and around the year.

It is another main object of this invention to enhance the effectiveness of harnessing gravitational energy.

It is another main object of this invention to enhance the efficiency of conversion of gravitational energy to other forms of energy, especially electrical energy.

It is another main object of this invention to allow for a heavy mass to fall freely under the influence of gravity, so as to increase the total work done, for harnessing and conversion; and to provide for controlling its fall and for lifting the said heavy mass back up, by a counterbalancing means such that the net weight that is lifted is the difference between the two, thereby increasing efficiency of the system.

It is another object of this invention to optimise the number of units employed, with the distance and speed of the free fall of the object/s with heavy mass, so as to achieve minimal input of power, and superlative efficiency.

It is yet another object of this invention to provide for auxiliary power generation mechanisms in the gravity power generation system to enhance overall output of power generated and thereby enhance the efficiency of the system.

### STATEMENT AND SUMMARY OF THE INVENTION

According to this invention, there is therefore provided an apparatus, system/s and method/s that on the one hand, maximise work done by gravity, by allowing free fall of an object with a heavy mass to harness energy and output therefrom, and on the other, maximises efficiency by counterbalancing this heavy mass by another mass such that only the net difference of the said two masses needs to be worked upon by input power mechanisms in order to lift the fallen object back up to its original position, along the direction of gravity or otherwise, to repeat the cycle. A plurality of such units are used in synchronised tandem to maintain a continuous movement of the gear/flywheel/shaft connecting a high output generator. Besides, this invention also envisages auxiliary energy generation mechanisms known in the art to further augment efficiency of the system; each such unit comprising;

(i) A hollow vertical channel, erected above ground level, provided with at least two guide rails along its inner walls through which (ii) a Main-weight comprising (ii)(a) an upper component called the ‘Head’ made of a material of suitable mass and density, preferably Titanium, shaped preferably corresponding to the cross section of the channel and provided with means at its periphery, that conform with and slide through and along 15 the said guide rails of the said vertical channel, and (ii)(b) a lower component being a vertical shaft made of a material of suitable mass and density, preferably Titanium, which bears teeth at least on one side of its length that engage a (iii) Main gear that in turn directly or through a flywheel and/or secondary gear/s, to rotate the (iv) Horizontal shaft of a generator, as the said vertical shaft moves downward with the falling Main weight due to the gravitational force. The said main gear is constructed like a free wheel so as to permit bi-directional engagement, and uni-directional rotation of the said Horizontal shaft of the generator, when the said vertical shaft moves downward.

(a) The upper said component (ii)(a) of the main weight is preferably (but not limited to) cylindrical, or cylindrical-oval, square-prism or such other shape corresponding to the said hollow vertical channel and depending on specific requirements of a project. For instance, where the project caters to large scale electricity generation wherein very heavy and large weight is used, it is preferable to use cylindrical, oval or square prism shape in order to accommodate a larger number of ropes to suspend the said weight. As the said main weight makes a downward freefall under the influence of gravity, its upper component or Head reaches the bottom of the hollow vertical channel where it is gradually halted with the help of (v) retarding/halting means that include but are not limited one or more of the following; Air Chamber/s, Air Pusher/s, spring/s, brakes, Electromagnet/s, Means that exert Lenz's force/s, Opposing movement of the Counterweight on the other side; and the Vertical shaft being the lower component of the said main weight enters a (vi) vertical subterranean hollow tube.

The said weight is suspended by (vii) ropes from a (viii) system of pulleys wherein the other ends of the said ropes are attached to (ix) a Counterweight, which is mounted on a (x) lift such that the said lift (along with the said counterweight) is suspended to slide upward and downward in (xi) a vertical frame erected parallel to the said hollow vertical 20 channel, such that the direction of movement of the Main weight is opposite that of the counterweight which is heavier than the main weight.

The Counterweight that counter-balances the Main weight, is mounted on a powered Lift system to carry it upwards at predetermined speeds to synchronize the falling Main weight such that revolution of the horizontal shaft of the generator is continuous. The said ropes in each unit run over a system of pulleys; each system comprising a plurality of rows of pulleys, designed to provide for auxiliary power generation so as to allow for mounting coils/magnets to produce electricity.

The synchronisation of upward-downward movements of the main weight and counterweight is executed with the help of (xii) sensors and signaling means to synchronize and control the movement of the counterweight and the main weight of one or more units, so as to maintain a continuous movement of the generator shaft.

### BRIEF DESCRIPTION OF THE DRAWINGS

FIG. 1: Schematically depicts two units and their constituents, wherein the Main weight of one unit is in its free falling/dropping phase while that of the other unit stands hoisted, in synchronized tandem.

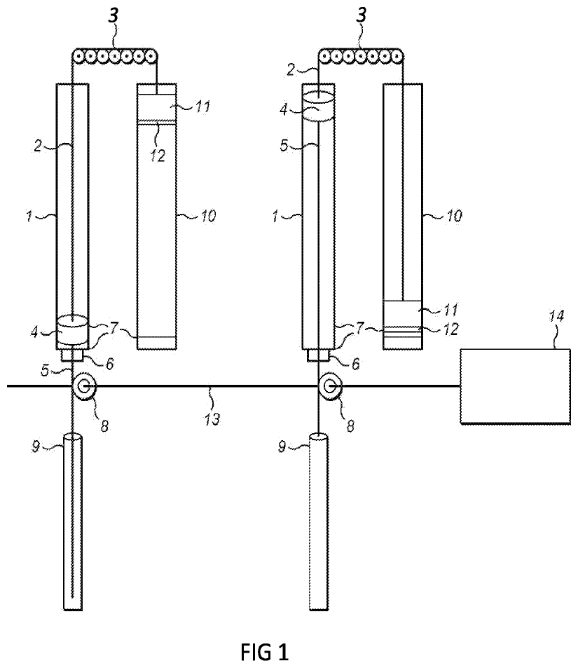

FIG. 2: Describes in perspective, the general layout for three units and their respective constituent parts.

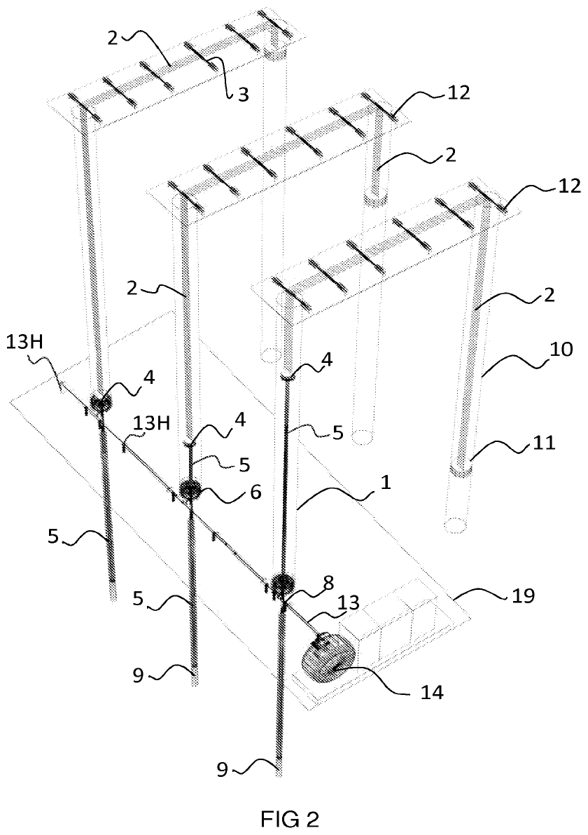

FIG. 3: Shows a close up focused on the Main weight as it drops to the bottom of the Hollow vertical channel while the retarding and halting means act on it.

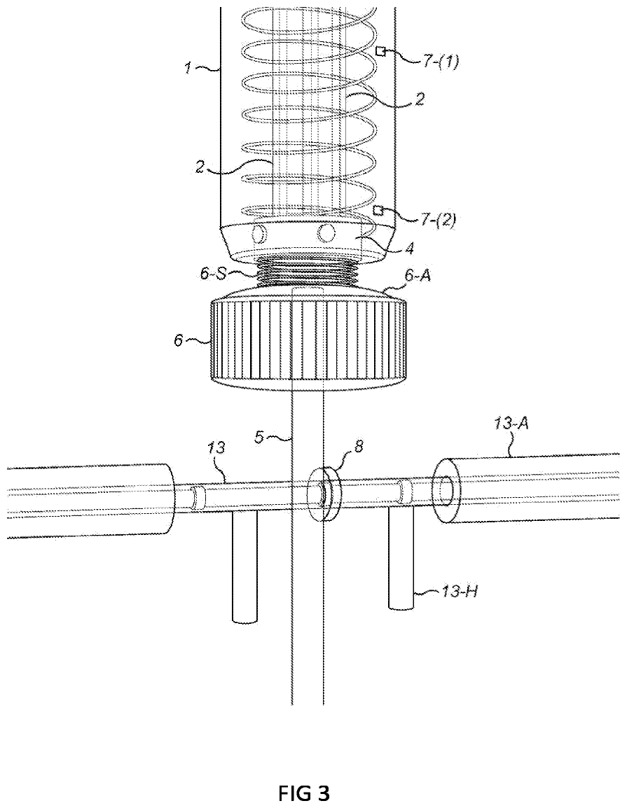

FIG. 4: Shows the Systems of pulleys and ropes suspending the Counterweight along with the Lift (as well as the Main weight—which is not shown), in perspective.

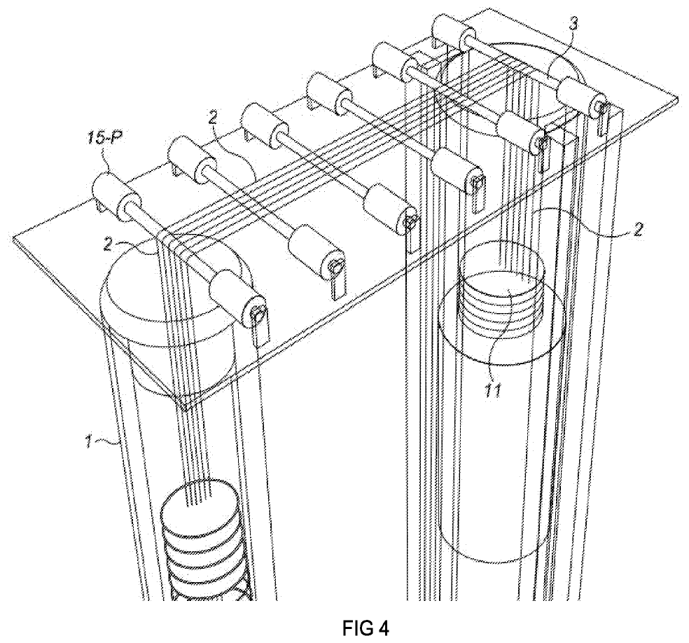

### INDEX OF ITEMS DESCRIBED IN THE DRAWINGS

1. Hollow vertical channel

2. Ropes

3. System of pulleys

4. Head of the Main-weight

5. Vertical shaft of the Main-weight

6. Halting and braking system within the Hollow vertical channel

6-A. Air pusher as part of braking system

6-S. Spring as part of braking system

7. Sensors and signaling means

7-(1). Sensor-1

7-(2). Sensor-2

8. Main gear

9. Vertical subterranean hollow tube

10. Vertical Frame

11. Counterweight

12. Lift

13. Horizontal shaft

13-A Auxiliary Power generating unit inSystem of Pulleys

13-H. Horizontal shaft holder

14. Generator

15. Auxiliary Power generating unit

15-P. Auxiliary Power generating unit inSystem of Pulleys

### DETAILED DESCRIPTION OF THE INVENTION

It is pertinent to mention that the description herein is meant to explain the design, construction and method/s by which the invention can be worked, more particularly and especially in a manner that applies to (but is not limited to) high capacity power generation plants, without limitation as to obvious alterations, modifications and adaptations of the parts, construction and method/s described; and that the diagrams/drawings herein are not drawn to scale but only serve to schematically explain the construction, working concept of the invention and represent the broad dimensions, shapes, spatial arrangement and inter-relationships of the parts, without limitation to their interchangeable or other obvious modifications and/or adaptations.

This invention anticipates material/s other than those specifically mentioned to describe the working embodiments, their various forms, adaptations and versions and various other metallic alloys and other combinations commonly used in the art for manufacture of power generation equipment.

Obvious and rather trivial details that do not warrant specific mention and which are known and obvious to a person skilled in the art are not mentioned and/or explained and/or drawn, while they are very much a part of this invention.

The description herein therefore shall not be construed to unduly limit the intended scope, spirit and extent of the invention.

### DETAILED DESCRIPTION AND WORKING OF PREFERRED EMBODIMENT

According to the preferred embodiment the apparatus, system/s that effectively harness and efficiently convert gravitational force/energy so as to generate large scale electric power comprising (without limitation and more particularly, to provide a simplistic example and explanation) three identical units wherein; each single unit comprises;

(i) A first hollow vertical cylindrical channel, 48 meters in height, inner diameter of 1 meters 30 cms, and wall thickness of 50 cm, erected above ground level, provided with at least two guide rails along its inner walls through which (ii) a Main-weight comprising (ii)(a) an upper component called the Head made of preferably (but not limited to) Titanium 30 cm in height, weighing 500 kg, diameter 1 m, cylindrical in shape, corresponding to the cross section of the channel and provided with rollers at its periphery, that conform with and slide through and along the said guide rails of the said vertical channel, and (ii)(b) a lower component being a vertical shaft preferably made of (but not limited to) Titanium 45 meters in length, and weighing 100 kg per meter of height, =4500 kgs in weight, and which bears teeth on one side along 40 meters, i.e., from top 5^{th} to bottom 44^{th} meter of its length that engage a main gear with a perimeter of 1 meter, that in turn directly rotates the Horizontal shaft of 0.96 meter radius of a generator, as the said vertical shaft moves downward with the falling Main weight due to the gravitational force at a velocity of 3 mtrs/sec=13.3 seconds for a fall of 40 meters, i.e., having due regard to the atmospheric air resistance, and the impedance offered by the gear on the Horizontal shaft that it is meshed with and rotates. The upper said component or Head (ii)(a) of the main weight is preferably (but not limited to) cylindrical, or cylindrical-oval, square-prism or such other shape corresponding to the said first hollow vertical channel and depending on specific requirements of a project. For instance, where the project caters to large scale electricity generation wherein very heavy and large weight is used, it is preferable to use cylindrical, oval or square prism shape in order to accommodate a larger number of ropes to suspend the said weight. The said Main gear acts as a free wheel so as to permit bi-directional engagement and uni-directional rotation i.e., when the said vertical shaft moves downward.

As the said Main weight makes a downward freefall under the influence of gravity, its upper component or Head reaches the bottom of the hollow vertical channel where it is gradually halted with the help of-a combination of Air Chamber/s, Air Pusher/s, spring/s, Brakes, Electromagnet/s, as well as by the Opposing movement of the Counterweight on the other side; and the Vertical shaft being the lower component of the said Main weight enters a vertical subterranean hollow tube 45 meters in depth.

The said weight is suspended by heavy duty: 24 mm traction ropes made up of (but not limited to) self lubricated fibre synthetic traction ropes, from a system of pulleys wherein the other ends of the said ropes are attached to (iii) a Counterweight, which is mounted on a lift such that the said lift (along with the said counterweight) is suspended to slide upward and downward in a vertical frame erected parallel to the said hollow vertical channel, such that the direction of movement of the Main weight is opposite that of the counterweight which according to this embodiment is marginally heavier than the main weight, i.e. 5100 Kg.

The Counterweight that more or less balances the main weight is mounted on a powered Lift system to carry it upwards at predetermined speeds to synchronize the falling weight such that revolution of the horizontal shaft of the generator is continuous. The said lift is powered by a 20 HP motor which lifts the counterweight at 45 meters in 15 seconds, whereby the power required is 12 KW in 15 seconds. Hence in this embodiment comprising 3 units, the total power consumed by each of the 3 lifts is (12 kw×4×60×24)=69 MW in a day. The main weight and counterweight of each unit are suspended by a set of 9 heavy duty 24 mm traction ropes.

The said ropes in each unit run along a system of Pulleys; each system comprising 12 rows of pulleys and hence a total of 36 pulleys are employed in this embodiment comprising 3 units. Each pulley is made of manganese bronze and has a diameter of 50 cm. Each system of Pulleys is designed to provide for auxiliary power generation so as to allow for mounting coils/magnets to produce electricity.

The synchronisation of upward-downward movements of the main weight and counterweight is executed with the help of Magnetic sensor/s which is placed at a distance of 40 meters from the apex of the first vertical channel, to control the movement of the counterweight and the main weight.

When the Head of the said Main-weight reaches the bottom of the first hollow Vertical channel at 40 meters depth, the Magnetic Sensor in Unit I will activate an Electronic Signal in the Lift of Unit I to exert necessary retarding effect by means of brakes or motion in the same direction as the Main weight of Unit I, thereby first controlling/retarding the fall of the said Main weight, and subsequently setting it in motion in the opposite direction to travel back upwards to its original position.

The said Sensor in Unit I, will also activate an Electronic signal in the Lift in Unit II to commence the free falling phase of the Main weight in Unit II. This cycle is repeated by the Magnetic Sensor in Unit II, in tandem, in order to signal to activate the Lift in Unit III to commence the free falling phase of the Main weight in Unit III, and likewise the cycle repeats for the Magnetic Sensor in Unit III , in tandem, in order to signal to activate the Lift in Unit Ito commence the free falling phase of the Main weight in Unit I, thereby ensuring that at least one vertical shaft (of one of the 3 Units) will be in its descending/dropping phase at any given time.

The Process/Method of Generation of Power/Electricity:

### Start-Up:

(a) According to this embodiment, since the Counterweight is heavier than the Main weight, the default position before start-up would be; the Main weight raised up at 45.5 meters height in the first vertical hollow channel and the Counterweight (along with the lift) stationed at the bottom of the vertical frame. The start-up operation would therefore involve, among others, operating the said Lift in an upward direction to allow the main weight to drop. This process step consumes the higher input power/energy particularly at the beginning of this step since the direction of movement of the Lift (along with the Counterweight) is against gravity. Moreover, as the falling weight gains momentum under the 20 influence of gravity it accelerates steadily whereby its velocity tends to increase linearly and the distance covered in unit time tends to increase quadratically. It is during this phase that maximum work is done by gravity which is harnessed by engaging the Vertical shaft of the Main weight to engage the Horizontal shaft of the generator to rotate. However, as the Main weight drops and reaches the bottom, it is gently retarded and halted by a retarding and halting mechanism comprising (but not limited to) brakes and Opposing movement of the Lift (along with the Counterweight) on the other side.

### Routine Operation

(b) In the next step (i.e., after the Main weight drops), the Lift (along with the Counterweight) which stands hoisted at the upper end of the vertical frame, is triggered by the sensor and signaling mechanism as explained hereabove, to commence downward movement. This downward movement consumes minimal power/energy for two reasons, (i) since the total weight of the Counterweight (along with the Lift) is greater than that of the Main weight on the other side, and (ii) this downward movement is along the direction of, (and is therefore additionally aided by) gravity. In embodiments comprising greater number of such units, this step can be executed even without running the lift on power since the heavier Counterweight would automatically overweigh the Main weight and lift it back up.

(c) The sensor and signaling mechanisms synchronise with the movement and direction of the Lift along with the Counterweight to ensure that at least one vertical shaft (of one of the 3 Units) will be in its descending/dropping phase at any given time to maintain continuous movement of the Horizontal shaft of the generator.

(d) This embodiment can therefore generate net power output in the range of at least 562 MW per day (having regard to 30% of power input consumed to sustain the upward-downward movement of the Mainweight and Counterweight.

(e) The ideal configuration for a plant would therefore be based on the quantum of power requirement, to optimise the number of units employed, with the distance and speed of the free fall of the object/s with heavy mass, so as to achieve minimal input of power and superlative efficiency.

### Embodiment II

In another embodiment, the input power requirements can be further minimised wherein all other conditions, parameters being the same as in the preferred embodiment I detailed above, the distinguishing features are;

(i) The System of Pulleys positioned horizontally above the vertical chamber and frame are connected to one or more motors powered either by an external source or by a part of the output energy generated by this invention in addition to the external source, so as to rotate in clock-wise and/or anti-clock wise direction to lift or drop the Main weight or Counterweight, as the case may be, either in addition to the said lifts as mentioned in embodiment 1 above or without the use of any lift.

(ii) In this embodiment, the means that run over the said pulleys and that suspend the weights need to exert sufficient friction and grip over the pulleys so as to preempt slipping. A good alternative to the said ropes as mentioned in the preferred embodiment I is (but not limited to) belts of suitable material known in the art, provided with teeth that mesh with the teeth of the said pulleys that are suitably modified to resemble gears with teeth to correspond to those in the said belts.

### Embodiment III

In another embodiment, the input power requirements can be further minimised wherein all other conditions, parameters being the same as in the preferred embodiment I detailed above, the only distinguishing features are;

(i) Each Main weight and Counterweight is further attached to an Upper lift (that positioned above the respective weight (i.e., Main weight or Counterweight) and a Lower lift positioned below the respective weight (i.e., Main weight or Counterweight) and wherein each of the said Upper and Lower lifts is detatchable from its respective weight.

(ii) The sensor and signaling mechanisms, based on a calculation that rationalises and optimises the distance, speed/velocity, and number of units in the system, govern the programmed attachment and detachment of the said lifts from their respective counterweights.

(iii) Each of the said lift has its own mass and weight which is constant across lifts in a given unit.

(iv) When a given lift attaches itself to its respective weight, while another lift detaches itself from its respective weight a disequilibrium or imbalance is brought about, which in turn causes the weight from which one or both lifts are detached to get automatically hoisted as the weight on the other side with both its respective lifts attached to it and therefore being heavier to drop, either freely under the influence of gravity or due to the powered movement of the respective lift/s.

This upward and downward movement, leverages gravitational force to the maximum and thereby minimizes the requirement of input power so as to achieve superlative power generative efficiency of the system.

1. An apparatus and system that maximises work done by gravity by allowing the free fall of a an object with a heavy mass and maximises efficiency by counterbalancing this heavy mass by another similar mass such that only the net difference of the said two masses needs to be worked upon by input power mechanisms in order to lift the fallen object back up to its original position, along the direction of gravity or otherwise, to repeat the cycle, wherein, a plurality of such units are used in synchronised tandem to maintain a steady RPM of the gear, flywheel and shaft connecting a high output generator, each unit comprising;
(i) A hollow vertical channel, erected above ground level, provided with at least two guide. rails along its inner walls,
(ii) a Main-weight comprising,
(ii)(a) an upper component called the ‘Head’, shaped preferably corresponding to the cross section of the channel and provided with means at its periphery, that conform with and slide through and along the said guide rails of the said vertical channel, and
(ii)(b) a lower component being a vertical shaft, which bears teeth at least on one side of its length,
(iii) a Main gear that engages with the teeth of the said vertical shaft, and which is connected to a Flywheel and/or other secondary gears,
(iv) a Horizontal shall of a generator, which is rotated directly by the said Main gear or through a flywheel and/or one or more intermediary secondary gears, as the said vertical shaft moves downward with the falling Main weight due to gravitational force.
(v) retarding and halting means directed towards gently retarding and halting the said Head of the tree falling Main weight as it reaches the bottom of the hollow vertical channel, over a predetermined time and distance, for synchronisation,
(vi) A vertical subterranean hollow tube to accommodate the said Vertical shaft of the Main weight as its Head reaches the bottom of the said hollow vertical channel,
(vii) a Counterweight, that counter-balances the main weight on the opposite side, mounted on a powered means to carry it upwards and downwards at predetermined speeds to synchronize the falling weight such that revolution of the horizontal shaft of the generator is kept constant.
(viii) one or more ropes for the suspension of the said Main weight and a Counterweight on either side of a system of pulleys, for upward-downward movement,
(ix) one or more systems of pulleys, each system comprising a plurality of pulleys over which the said ropes in each unit run, to carry upward and drop or slide downward the said Main weight and Counterweight,
(x) Means to initiate and sustain the upward and downward, movement of either the said Main weight or Counter weight or both,
(xi) a vertical frame erected parallel to the said hollow vertical channel, within which the said means move the Main weight or Counter weight upward or downward, in counterbalance,
(xii) sensors, signalling means and speedometers to control and synchronize the velocity of the said counterweight and hence that of the said Main weights of a plurality of units, so as to maintain a steady RPM of the generator shaft;
such that, at any given moment during operation, at least one Main weight (including its vertical shaft) is in its freefall phase to engage arid rotate (the gear of) the horizontal shaft of the generator.

2. The Apparatus and system as claimed in claim 1 wherein the said upper component (ii)(a) of the Main weight is cylindrical, cylindrical-oval, square-prism of such other shape corresponding to the said hollow vertical channel to suit the specific requirements of a given project,

3. The apparatus and system as claimed in claims 1 and 2 wherein the said Main gear is constructed like a free wheel so as to permit preferably bi-directional engagement and unidirectional rotation of the said Horizontal shaft of the generator when the said vertical shaft meshes with it as it drops/slides downward.

4. The Apparatus and System as claimed in claims 1 to 3 wherein the retarding and halting means directed towards gently retarding and halting the said Head of the free falling Main weight as it reaches the bottom of the hollow vertical channel is one or more of the following:
(a) Air Chamber/s,
(b) Air Pusher/s,
(c) spring/s,
(d) Brakes,
(e) Electromagnet's or
(f) Means that exert Lenz's force/s;
(g) Opposing movement of the Counterweight on the other side,

5. The Apparatus and System as claimed in claims 1 to 4 wherein the said Counterweight is as heavy as the said Main weight,

6. The Apparatus and System as claimed in any of the claims 1 to 4 wherein the said Counterweight is 3% to 10% heavier than the said Main weight,

7. The Apparatus and System as claimed in any of the claims 1 to 4 wherein the said Counterweight is 3% to 10% lighter than the main weight,

8. The Apparatus and System as claimed in any of the claims 1 to 7 wherein the said means to carry the said Counterweight, in collaboration with the sensor and signalling means, counter-balances the main weight upwards and downwards at predetermined speeds to synchronize the falling weight such that revolution of the horizontal shaft of the generator is kept constant.

9. The Apparatus and System as claimed in any of the claims 1 to 8 wherein the said means to carry the said Main weight or Counterweight is detachable from the said Main weight or Counterweight and is powered by an external power source.

10. The Apparatus and System as claimed in airy of the any of the claims 1 to 8 wherein the said means to carry the said Main weight or Counterweight is detachable from the said Main weight or Counterweight is powered by feeding back part of power generated by one or more units of this invention, or partially or alter natively by an external power source,

11. The Apparatus and System as claimed in any of the claims 1 to 10 wherein sensors to control and synchronize the velocity of the said counterweight and hence that of the said Main weight of one or more units, so as to maintain a steady RPM of the generator shaft are one or more of the following; (a) Magnetic sensors, (b) Light beam/Laser sensors, (c) Passive Infrared sensors, (d) Knock sensor, (e) Pressure sensor, (f) Proximity sensor, (g) electric sensor,

12. The Apparatus and System as claimed in claims 1 through 11 wherein means for auxiliary power are provided by suitable adaptation/modification to install coils and magnets to produce electricity in one or more of the following components or parts; (a) Pulleys and rods, (b) vertical channel and Main weight, (c) vertical frame arid Counterweight, (d) horizontal shaft and gears, (e) Vertical shaft and subterranean hollow tube.

13. The Apparatus and System as claimed in any of the claims 1 through 12 wherein the means to initiate and sustain the upward-downward movement of the Main weight and Counter weight is a powered motor fitted on one or more pulleys of the said System of Pulleys.

14. The method of generating power, employing a plurality of units as claimed in any of the claims 1 through 13, wherein in any given unit, an object with a heavy mass is allowed to fall freely under the influence of gravity from a substantial height in order to provide for its velocity increase linearly while the distance it covers tends to increase quadratically over time, such that maximal force. of gravity is made available to be harnessed by directing the said force to rotate, either directly or through a flywheel and/or gear/s, the shaft of a high power generator.

15. The method of generating power as claimed in claim 14 wherein the weight of the said free falling object with the heavy mass, is constantly counterbalanced by a Counterweight such that the net weight that is lifted, either by an external power source or by power fed back from the output of this system, is merely the difference between the two, thereby increasing efficiency of the system.

16. The method of generating power, as claimed in claims 14 and 15 wherein the number of units employed is optimised in conjunction with the distance and speed of the free fall of the object/s with heavy mass, whereby upward or downward movement of either the Main weight or the Counterweight in any given unit is passive and entirely driven by gravity alone, so as to achieve minimal input of power, and superlative efficiency.

17. The method of generating power, as claimed in claims 14, 15 and 16 wherein, time, distance and speed of the Main weights and Counterweights are synchronized such that the vertical shaft of at least one unit is in its free falling/dropping phase at any given time to sustain a steady rate of revolution of the generator shaft, during which the vertical shafts of other unit/s are in the process of being lifted to fall downward in synchronised tandem,

18. The Apparatus and System that maximises work done by gravity by allowing free fall of a an object with a heavy mass and maximise efficiency by counterbalancing this heavy mass by another similar mass such that only the net difference of the said two masses needs to be worked upon by input power mechanisms in order to lift the fallen object back up to its original position, along the direction of gravity or otherwise, to repeat the cycle, wherein, a plurality of such units are used in synchronised tandem to maintain a steady RPM of the gear, flywheel and shaft connecting a high output generator, substantially as herein described.

19. The method of generating power, employing a plurality of units, wherein in any given unit, an object with a heavy mass is allowed to fall freely under the influence of gravity from a substantial height in order to provide for its velocity to increase linearly while the distance it covers tends to increase quadratically over time, such that maximal force of gravity is made available to be harnessed by directing the said force to rotate, either directly or through a flywheel and/or gear/s, the shaft of a high power generator, substantially as herein described.
